(19) United States
(12) Patent Application Publication
(10) Pub. No.: US 2005/0251309 A1
(43) Pub. Date: Nov. 10, 2005

(54) Digital recorder assembly for a vehicle

(76) Inventor: Pawel W. Sleboda, Bloomfield Hills, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/840,445

(22) Filed: May 6, 2004

(51) Int. Cl. G06F 19/00

(52) U.S. Cl. 701/36; 307/10.1

(57) ABSTRACT

A digital recorder assembly for a vehicle includes an interior vehicle component and a digital recorder. The interior vehicle component includes a docking location having a communication interface. The digital recorder is adapted to be positioned within the docking location and has a communication interface communicable to the communication interface of the docking location. When the digital recorder is positioned within the docking location, the communications interface of the docking location may be capable of transferring power from a vehicle power source to a power supply of the digital recorder or the communications interface of the digital recorder may be capable of transferring data from the digital recorder to an audio system of the vehicle. The digital recorder may have a plurality of switches operable to control the operation of the digital recorder when the interior component is in a first position or a second position.

### BACKGROUND OF THE INVENTION

This invention relates in general to motor vehicles and, more particularly, to a digital recorder assembly for use in a vehicle interior compartment.

Various portable digital recording devices are known for recording and playing back relatively short messages. These devices are generally battery powered devices and may be pocket-sized for convenience of storage and transport. These devices allow a user to record an audio signal, generally a voice message, and the message is then stored in the memory of the recording device. The message may then be recalled and played at the request of the user or by another triggering event.

It would be desirable to incorporate such a portable digital recording device into a vehicle to allow a user within a vehicle easy access to the digital recording device. It would also be desirable to facilitate communication between a digital recording device and a vehicle so that the recording device and vehicle could share a power source and data therebetween.

### BRIEF SUMMARY OF THE INVENTION

The present invention is directed towards a digital recorder assembly for use in a motor vehicle that meets the foregoing needs. The digital recorder assembly includes an interior vehicle component and a digital recorder. The interior vehicle component includes a docking location having a communication interface. The digital recorder is adapted to be positioned within the docking location and has a communication interface communicable to the communication interface of the docking location. In a preferred embodiment, the communications interface of the docking location may be capable of transferring power from a vehicle power source to a power supply of the digital recorder when the digital recorder is positioned within the docking location. In a preferred embodiment, the communications interface of the digital recorder may be capable of transferring data from the digital recorder to an audio system of the vehicle when the digital recorder is positioned within the docking location. In a further preferred embodiment, the digital recorder may have a plurality of switches operable to control the operation of the digital recorder when the interior component is in a first position or a second position.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a portion of a vehicle and a first embodiment of a digital recorder, in accordance with the present invention.

FIG. 2 is a perspective view of a portion of a vehicle interior compartment including the first embodiment of the digital recorder and a second embodiment of the digital recorder in accordance with the present invention.

FIG. 3 is perspective view of a portion of a vehicle interior compartment including a third embodiment of a digital recorder, a fourth embodiment of a digital recorder, and a fifth embodiment of a digital recorder, each in accordance with the present invention.

FIG. 4 is perspective view of a vehicle interior compartment including a sixth embodiment of a digital recorder, a seventh embodiment of a digital recorder, an eighth embodiment of a digital recorder, and a ninth embodiment of a digital recorder, each in accordance with the present invention.

### DETAILED DESCRIPTION OF THE PREFERRED EMBODIMENT

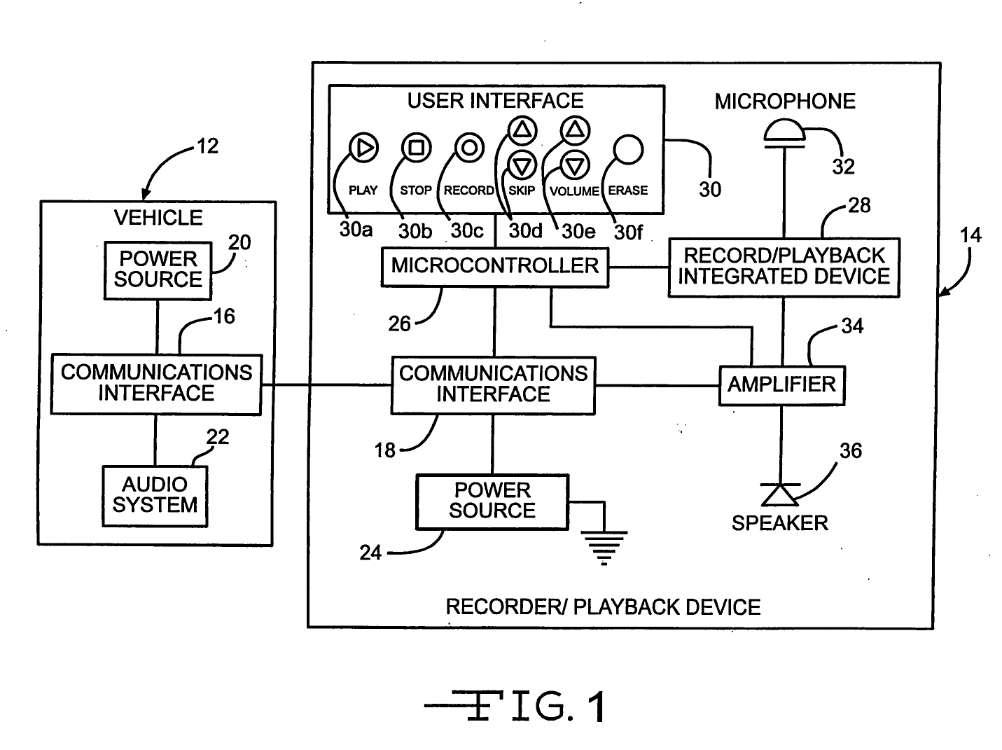

Referring now to the drawings, there is illustrated in FIG. 1 a first embodiment of a digital recorder assembly, indicated generally at 10, in accordance with the present invention. The digital recorder assembly 10 includes a portion of a vehicle 12. The illustrated motor vehicle 12 is, in large measure, conventional in the art and is intended merely to illustrate one environment in which this invention may be used. Thus, the scope of this invention is not intended to be limited for use with the specific structure for the motor vehicle 12 illustrated in FIG. 1. On the contrary, as will become apparent below, this invention may be used in any desired environment for the purposes described below.

The digital recorder assembly 10 also includes a digital recorder, indicated generally at 14, in accordance with this invention. The illustrated digital recorder is, in large measure, conventional in the art and is intended merely to illustrate one configuration of a digital recorder to be used in this invention. Thus, the scope of this invention is not intended to be limited for use with the specific structure for the digital recorder illustrated in FIG. 1. On the contrary, as will become apparent below, various electrical components may be used in various configurations to construct the digital recorder in accordance with the present invention.

The digital recorder 14 is a digital recording device capable of storing and retrieving digital data representative of an inputted audio signal. The digital recorder 14 is also capable of outputting an audio signal representative of the retrieved digital data, such that the originally inputted audio signal may be reproduced. The operation of the digital recorder 14 is well known in the art and will not be described in detail herein. Various digital recording devices with the capabilities described herein are known in the art and may comprise the digital recorder 14.

The digital recorder 14 is detachable from the vehicle 12 and may be fully functional when removed from the vehicle 12. The vehicle 12 and/or the digital recorder 14 may include various slots, recesses, tabs, and/or other structures to facilitate the attachment and removal of the digital recorder 14 to and from the vehicle 12, as will be described in more detail herein. The digital recorder 14 may be any size and shape. Preferably, the digital recorder 14 is portable and pocket-sized. A pocket-sized object is generally an object that is sized so that the sum of a perimeter and height of the object is equal to or less than about 400 millimeters.

The vehicle 12 has a communication interface 16 communicable with a communication interface 18 of the digital recorder 14. The communication interface 16 and communication interface 18 may be any communicably connectable corresponding interfaces, such as IDE/ATA (integrated drive electronics or AT attachment), SCSI (Small Computer System Interface), PCI (Peripheral Component Interconnect) interfaces, other multi-pin corresponding interfaces, or corresponding power transfer devices. In a preferred embodiment, the communication interface 16 of the vehicle 12 and the communication interface 18 of the digital recorder 14 are corresponding IDE/ATA (integrated drive electronics or AT attachment) interfaces, and may use any ATA standard specification. However, the communication interface 16 and communication interface 18 may be may be any devices that are communicably connectable to one another to transmit power and/or digital data. Further, the communication interface 16 and the communication interface 18 may be connected by a digital wire connection, such as a pair of IDE connectors on either end of an IDE cable, with each of the IDE connectors attached to a respective one of the communication interface 16 and the communication interface 18 or any other suitable ribbon wire and connector combination. However, it will be appreciated that the communication interface 16 and the communication interface 18 may be communicably connectable in any manner.

In a preferred embodiment, the communications interface 16 may be communicably connected to a power source 20 of the vehicle 12 to transfer power from the power source 20 through the communications interface 16, although such is not required. The communications interface 16 may include additional electrical components, such as a rechargeable battery charger unit, to convert the power received from the power source 20 into the desired power to be distributed through the communications interface 16.

In a preferred embodiment, the communications interface 16 may be communicably connected to an audio system 22 of the vehicle 12 to transfer data from the audio system 22 through the communications interface 16, although such is not required. The communication interface 16 and the communication interface 18 are capable of sending and/or receiving or both sending and receiving digital data that may include data beyond the digital data representative of the stored digital recorder audio data. The digital data transferred between the communication interface 16 and the communication interface 18 preferably includes commands to control one of components of the vehicle 12 and the recorder 14. Thus, the communication interface 16 and the communication interface 18 may function to transfer additional data beyond the digital data conventionally transferred through a digital audio input or output, although such is not required.

In a preferred embodiment, the communications interface 18 may be communicably connected to a power source 24 of the digital recorder 14. The power source 24 may be any power source capable of supplying the digital recorder 14 with the power required to operate as described herein. The power source 24 is communicably connected to the components of the digital recorder 14 to provide power to the components as required for operation of the digital recorder 14. In a preferred embodiment, the power source 24 may supply the digital recorder 14 with the power required to operate when the communications interface 18 is not communicably connected to the communications interface 16. In a further preferred embodiment, the power source 24 may include a rechargeable battery. In a preferred embodiment, the communications interface 16 may be communicably connected to a power source 20 of the vehicle 12 to transfer power from the power source 20 through the communications interface 16 and the communications interface 18 to the power source 24. The power source 20 may recharge the power source 24, although such is not required. In a further preferred embodiment, the power source 20 of the vehicle 12 may supply the digital recorder 14 with the power required to operate when the communications interface 18 is communicably connected to the communications interface 16. The communications interface 16, communications interface 18, and/or the power source 24 may include additional electrical components, such as a rechargeable battery charger unit, to convert the power received from the power source 20 into the desired power to be distributed to the power source 24.

In a preferred embodiment, the communications interface 16 may be communicably connected to the communications interface 18 to transmit power from the power source 20 of the vehicle 12 to the power source 24 of the digital recorder 14. It will be appreciated that the communications interface 16 and the communications interface 18 may be capable of only transmitting power from the communications interface 16 to the communications interface 18, and that data transfer between the communications interface 16 and the communications interface 18 is not required in accordance with the invention.

The digital recorder 14 further includes a microcontroller 26 communicably connected to the communications interface 18. The microcontroller 26 may receive and/or transmit data from and/or to the communications interface 18, if the communications interface 18 is adapted to receive and/or transmit data. The microcontroller 26 and a record/playback integrated device 28 are communicably connected and cooperate to store and retrieve digital data representative of an inputted audio signal. The microcontroller 26 and the record/playback integrated device 28 are also capable of outputting an audio signal representative of the retrieved digital data, such that the originally inputted audio signal is reproduced. In a preferred embodiment, the microcontroller 26 is a peripheral interface controller (PIC), such as a 12-bit core microchip PIC with a two wire port and switch input buffer, and the record/playback integrated device 28 is a single microchip integrated device adapted to perform record and playback functions including integrated memory, DSP, DAC, and amplification devices, such as the ISD5100 series microchips available from Winbond Electronics Corporation. It will be appreciated that the microcontroller 26 and the record/playback integrated device 28 may be any devices that cooperate to perform the functions described herein. It will further be appreciated the either the microcontroller 26 or the record/playback integrated device 28 may comprise additional electronic components as necessary to perform such functions, and each may perform the functions described herein for the other.

The digital recorder 14 further includes a user interface 30 that is configured to allow a user to input commands to control the operation of the digital recorder 14. The user interface 30 may also communicate information regarding the operation of the digital recorder 14. The user interface 30 may include at least one button, track ball, touch screen device, and switch to allow a user to input various commands. As illustrated, the user interface 30 includes a plurality of switches 30a, 30b, 30c, 30d, 30e, and 30f, although such is not required. Each of the plurality of switches 30a, 30b, 30c, 30d, 30e, and 30f allow a user to control a function or operating parameter of the digital recorder 14.

Each of the plurality of switches 30a, 30b, 30c, 30d, 30e, and 30f may allow a user to enter a command to control the operation of the digital recorder 14. For example, when depressed, the switch 30a may instruct the digital recorder 14 to begin playing the current message. The switch 30b may instruct the digital recorder 14 to stop the current operation. The switch 30c may instruct the digital recorder 14 to begin recording an audio signal. The switch 30d may instruct the digital recorder 14 to move forward or backward to the next message or previous message depending on the portion of the switch 38 that is depressed. The switch 30e may control the volume of the signal output of the digital recorder 14. The switch 30f may instruct the digital recorder 14 to erase the current message.

The digital recorder 14 includes a microphone 32. The microphone 32 allows an audio signal representative of a sound detected by the microphone 32 to be inputted into the digital recorder 14. As illustrated, the microphone 32 is communicably connected to the record/playback integrated device 28, although such is not required. It will be appreciated that the microphone 32 may alternatively be communicably connect to the microcontroller 26.

The digital recorder 14 may further include an amplifier 34. The amplifier 34 is conventional in the art and may be connected to the record/playback integrated device 28 to receive an audio signal to be amplified. The amplifier 34 may additional be connected to the microcontroller 26, as illustrated, or alternatively the record/playback integrated device 28 to control the amplification of the audio signal. Additionally or alternatively, it will be appreciated that the record/playback integrated device 28 may include an amplifier and the amplifier 34 may not be required to practice the invention.

The digital recorder 14 further includes a speaker 36 communicably connected to the amplifier 34, as illustrated, or alternatively, communicably connected to the microcontroller 26 or record/playback integrated device 28. The speaker 36 may be any known speaker device.

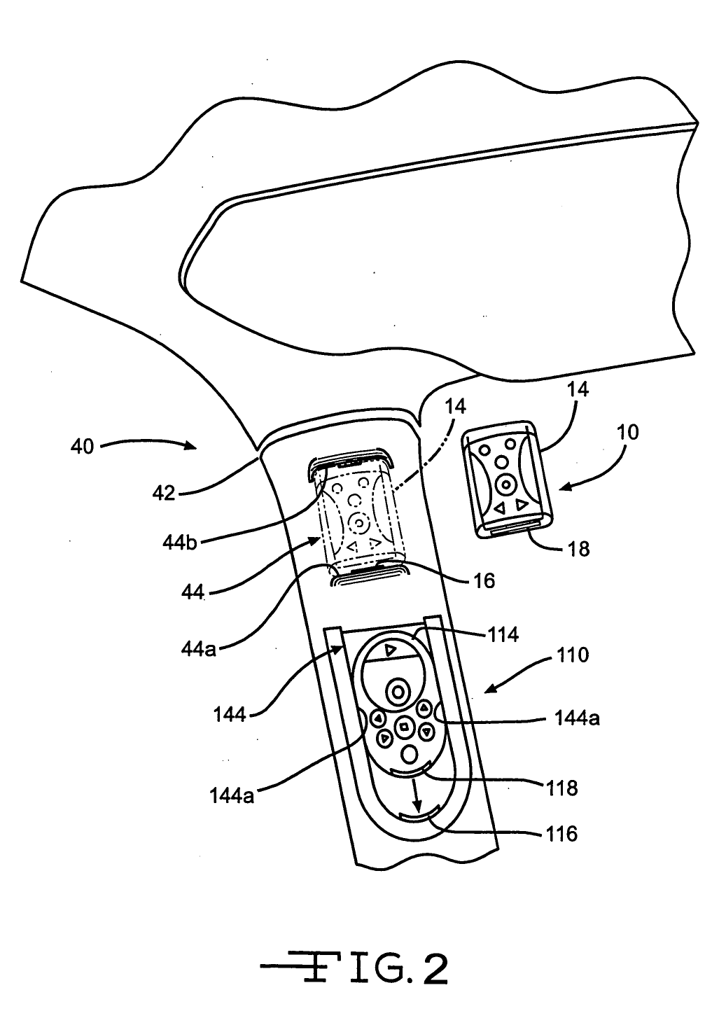

Referring now to FIG. 2, there is illustrated a portion of an interior of a vehicle 40 having an interior vehicle component 42. The illustrated interior 40 and interior vehicle component 42 are, in large measure, conventional in the art and are intended merely to illustrate one environment in which this invention may be used. Thus, the scope of this invention is not intended to be limited for use with the specific structure for the interior 40 or interior vehicle component 42 illustrated in FIG. 2 or with interior vehicle components in general. On the contrary, as will become apparent below, this invention may be used in any desired environment for the purposes described below.

The interior vehicle component 42 is illustrated as a vehicle frame pillar, or more particularly, an A-pillar of a vehicle, although such is not required. It will be appreciated that the interior vehicle component 42 may be any interior vehicle component, such as instrument panels, door panels, center consoles, overhead consoles, seat assemblies, armrests, visors, and other various interior panels for covering the sides, ceilings, vertical pillars of the frame members of the vehicle or any other component located within the interior of a vehicle.

The interior vehicle component 42 includes the first embodiment of the digital recorder assembly 10 having a docking location 44. As illustrated, the docking location 44 comprises a lower lip 44a and an upper lip 44b molded within the interior vehicle component 42. The lower lip 44a and the upper lip 44b are shaped to tightly fit around opposed sides of the digital recorder 14 to hold the digital recorder 14 to the interior vehicle component 42, as indicated in phantom lines at 14 in FIG. 2. The lower lip 44a and the upper lip 44b may be shaped such that the digital recorder 14 is held therebetween in a snap-fit, although such is not required. Additional fasteners (not shown), such as removable adhesives and hook and loop fasteners, may be provided within the docking location 44 to facilitate the attachment of the digital recorder 14 to the docking location 44. Located within the lower lip 44a is the communication interface 16. The lower lip 44a may be shaped to partially shield the communication interface 16 from contact with other objects or users within the interior of the vehicle 40, although such is not required.

The interior vehicle component 42 includes a second embodiment of a digital recorder assembly 110 having a docking location 144. The digital recorder assembly 110 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the second embodiment of the digital recorder assembly 110 as illustrated in FIG. 2. Therefore, such corresponding components are indicated by similar reference number in these Figures, but with the components of the second embodiment of the digital recorder assembly 110 having the addition of 100 to each reference number.

As illustrated, the docking location 144 comprises a pair of slots 144a. The pair of slots 144a are shaped to tightly fit around opposed sides of a digital recorder 114 to hold the digital recorder 114 to the interior vehicle component 42. A lower lip 144b may connect each of the pair of slots 144a to one another, and vertically support the digital recorder 144 within the docking location 144. Located within the lower lip 144b is the communication interface 116. The lower lip 144b may be shaped to partially shield the communication interface 116 from contact with other objects or users within the interior of the vehicle 40, although such is not required. As illustrated in FIG. 2, the digital recorder 114 is disposed within the pair of slots 144a, such that the digital recorder 114 slidingly engages the docking location 144. However, the digital recorder 114 is not completely disposed within the docking location 114, such that the digital recorder 114 contacts the lower lip 144b and the communications interface 116 is communicably connected to the communications interface 118. Additional fasteners (not shown), such as removable adhesives and hook and loop fasteners, may be provided within the docking location 144 to facilitate the attachment of the digital recorder 114 to the docking location 144.

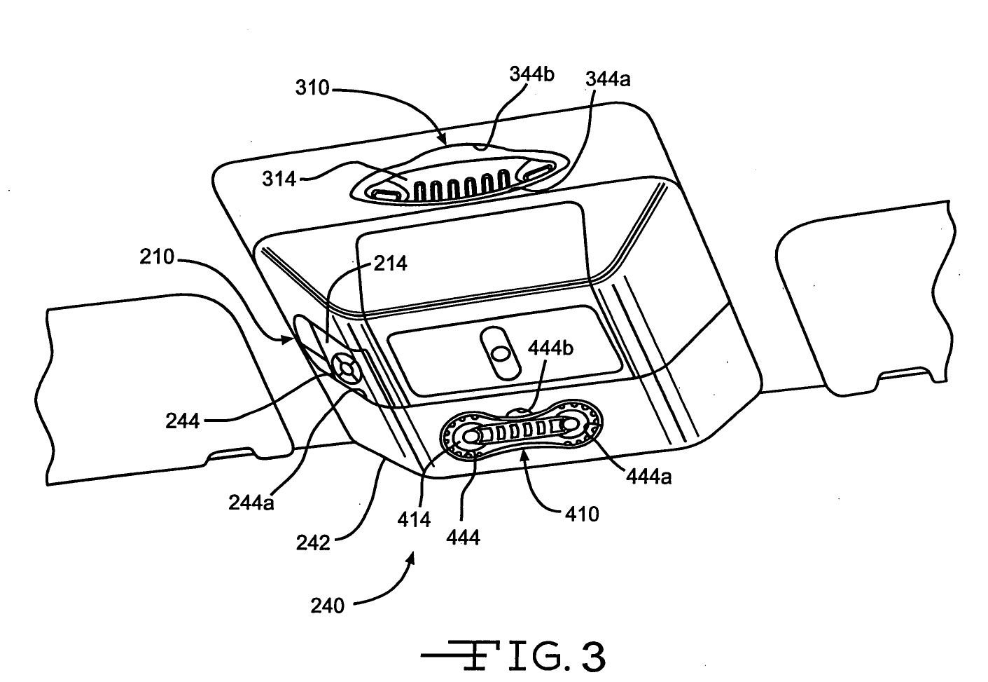

Referring now to FIG. 3, there is illustrated a portion of an interior of a vehicle 240 having an interior vehicle component 242. The illustrated interior 240 and interior vehicle component 242 are, in large measure, conventional in the art and are intended merely to illustrate one environment in which this invention may be used. Thus, the scope of this invention is not intended to be limited for use with the specific structure for the interior 240 or interior vehicle component 242 illustrated in FIG. 3 or with interior vehicle components in general. On the contrary, as will become apparent below, this invention may be used in any desired environment for the purposes described below.

The interior vehicle component 242 is illustrated as an overhead console, although such is not required. It will be appreciated that the interior vehicle component 242 may be any interior vehicle component, such as instrument panels, door panels, center consoles, seat assemblies, armrests, visors, and other various interior panels for covering the sides, ceilings, vertical pillars of the frame members of the vehicle or any other component located within the interior of a vehicle.

The interior vehicle component 242 includes a third embodiment of the digital recorder assembly 210 having a docking location 244. The digital recorder assembly 210 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the third embodiment of the digital recorder assembly 210 as illustrated in FIG. 3. Therefore, such corresponding components are indicated by similar reference number in these Figures, but with the components of the third embodiment of the digital recorder assembly 210 having the addition of 200 to each reference number.

As illustrated, the docking location 244 comprises a recess 244a molded within the interior vehicle component 242. The recess 244a is shaped to tightly fit around the digital recorder 214 to hold the digital recorder 214 to the interior vehicle component 242, as indicated in FIG. 3. The recess 244a may be shaped such that the digital recorder 214 is held therein in a snap-fit, although such is not required. Additional fasteners (not shown), such as removable adhesives and hook and loop fasteners, may be provided within the docking location 244 to facilitate the attachment of the digital recorder 214 to the docking location 244. Located within the recess 244a is a communication interface (not shown). The recess 244a may be shaped to partially shield the communication interface from contact with other objects or users within the interior of the vehicle 240, although such is not required. As illustrated in FIG. 3, the digital recorder 214 is disposed within the recess 244a such that the communication interface (not shown) of the digital recorder 214 is communicably connected to a communications interface (not shown) of the docking location 244. Additional fasteners (not shown), such as removable adhesives and hook and loop fasteners, may be provided within the docking location 244 to facilitate the attachment of the digital recorder 214 to the docking location 244.

The interior vehicle component 242 includes a fourth embodiment of a digital recorder assembly 310 having a docking location 344. The digital recorder assembly 310 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the fourth embodiment of the digital recorder assembly 310 as illustrated in FIG. 3. Therefore, such corresponding components are indicated by similar reference number in these Figures, but with the components of the fourth embodiment of the digital recorder assembly 310 having the addition of 300 to each reference number.

As illustrated, the docking location 344 comprises a recess 344a. The recess 344a is shaped to tightly fit around the digital recorder 314 to hold the digital recorder 314 to the interior vehicle component 242. Located within the recess 344a is a communication interface (not shown). The recess 344a may be shaped to partially shield the communications interface from contact with other objects or users within the interior of the vehicle 240, although such is not required. As illustrated in FIG. 3, the digital recorder 314 is disposed within the recess 344a such that the communication interface (not shown) of the digital recorder 314 is communicably connected to a communications interface (not shown) of the docking location 344. Additional fasteners (not shown), such as removable adhesives and hook and loop fasteners, may be provided within the docking location 344 to facilitate the attachment of the digital recorder 314 to the docking location 344. The docking location 344 may include an aperture 344b. The aperture 344b may be shaped such that the aperture 344b remains open to the recess 344a and the digital recorder 314 when the digital recorder 314 is disposed within the recess 344a. The aperture 344b may facilitate the removal of the digital recorder 314 from the recess 344a by allowing a user to more securely grab the digital recorder 314 when disposed within the recess 344a.

The interior vehicle component 242 includes a fifth embodiment of a digital recorder assembly 410 having a docking location 444. The digital recorder assembly 410 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the fifth embodiment of the digital recorder assembly 410 as illustrated in FIG. 3. Therefore, such corresponding components are indicated by similar reference number in these Figures, but with the components of the fifth embodiment of the digital recorder assembly 410 having the addition of 400 to each reference number.

As illustrated, the docking location 444 comprises a recess 444a. The recess 444a is shaped to tightly fit around the digital recorder 414 to hold the digital recorder 414 to the interior vehicle component 242. Located within the recess 444a is a communication interface (not shown). The recess 444a may be shaped to partially shield the communications interface from contact with other objects or users within the interior of the vehicle 240, although such is not required. As illustrated in FIG. 3, the digital recorder 414 is disposed within the recess 444a such that the communication interface (not shown) of the digital recorder 414 is communicably connected to a communications interface (not shown) of the docking location 444. Additional fasteners (not shown), such as removable adhesives and hook and loop fasteners, may be provided within the docking location 444 to facilitate the attachment of the digital recorder 414 to the docking location 444. The docking location 444 may include an aperture 444b. The aperture 444b may be shaped such that the aperture 444b remains open to the recess 444a and the digital recorder 414 when the digital recorder 414 is disposed within the recess 444a. The aperture 444b may facilitate the removal of the digital recorder 414 from the recess 444a by allowing a user to more securely grab the digital recorder 414 when disposed within the recess 444a.

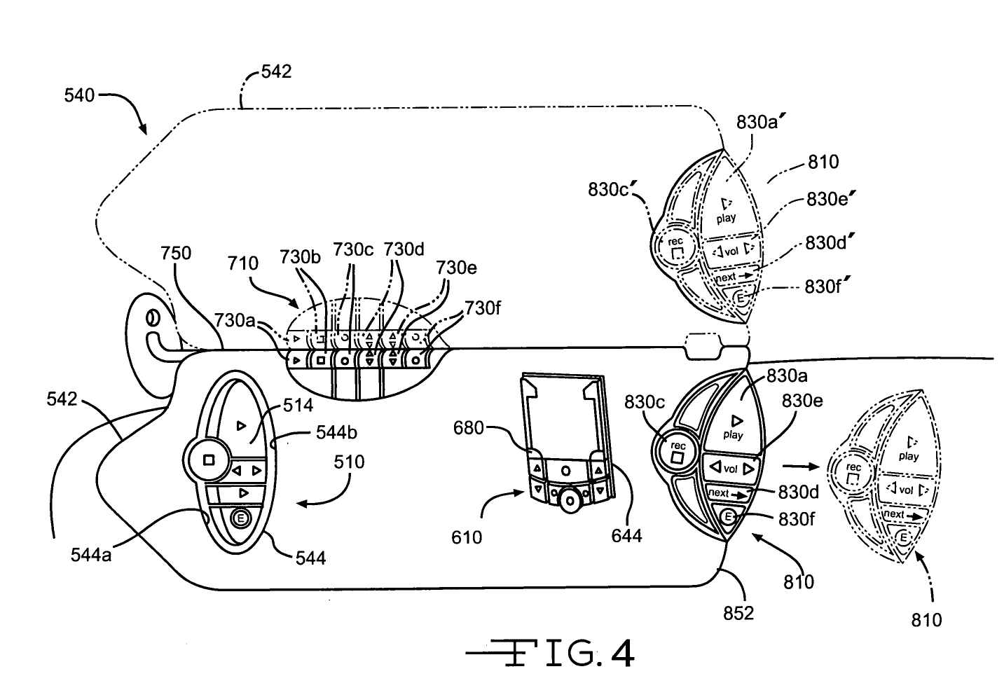

Referring now to FIG. 4, there is illustrated a portion of an interior of a vehicle 540 having an interior vehicle component 542. The illustrated interior 540 and interior vehicle component 542 are, in large measure, conventional in the art and are intended merely to illustrate one environment in which this invention may be used. Thus, the scope of this invention is not intended to be limited for use with the specific structure for the interior 540 or interior vehicle component 542 illustrated in FIG. 4 or with interior vehicle components in general. On the contrary, as will become apparent below, this invention may be used in any desired environment for the purposes described below.

The interior vehicle component 542 is illustrated as a visor, although such is not required. It will be appreciated that the interior vehicle component 542 may be any interior vehicle component, such as instrument panels, door panels, center consoles, overhead consoles, seat assemblies, armrests, and other various interior panels for covering the sides, ceilings, vertical pillars of the frame members of the vehicle or any other component located within the interior of a vehicle.

The interior vehicle component 542 includes a sixth embodiment of the digital recorder assembly 510 having a docking location 544. The digital recorder assembly 510 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the sixth embodiment of the digital recorder assembly 510 as illustrated in FIG. 4. Therefore, such corresponding components are indicated by similar reference number in these Figures, but with the components of the sixth embodiment of the digital recorder assembly 510 having the addition of 500 to each reference number.

As illustrated, the docking location 544 comprises a recess 544a molded within the interior vehicle component 542. The recess 544a is shaped to tightly fit around the digital recorder 514 to hold the digital recorder 514 to the interior vehicle component 542, as indicated in FIG. 4. The recess 544a may be shaped such that the digital recorder 514 is held therein in a snap-fit, although such is not required. Additional fasteners (not shown), such as removable adhesives and hook and loop fasteners, may be provided within the docking location 544 to facilitate the attachment of the digital recorder 514 to the docking location 544. Located within the recess 544a is a communication interface (not shown). The recess 544a may be shaped to partially shield the communication interface from contact with other objects or users within the interior of the vehicle 540, although such is not required. As illustrated in FIG. 4, the digital recorder 514 is disposed within the recess 544a such that the communication interface (not shown) of the digital recorder 514 is communicably connected to a communications interface (not shown) of the docking location 544. The docking location 544 may include an aperture 544b. The aperture 544b may be shaped such that the aperture 544b remains open to the recess 544a and the digital recorder 514 when the digital recorder 514 is disposed within the recess 544a. The aperture 544b may facilitate the removal of the digital recorder 514 from the recess 544a by allowing a user to more securely grab the digital recorder 514 when disposed within the recess 544a.

The interior vehicle component 542 includes a seventh embodiment of a digital recorder assembly 610 having a docking location 644. The digital recorder assembly 610 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the seventh embodiment of the digital recorder assembly 610 as illustrated in FIG. 4. Therefore, such corresponding components are indicated by similar reference number in these Figures, but with the components of the seventh embodiment of the digital recorder assembly 610 having the addition of 600 to each reference number.

Additional fasteners (not shown), such as removable adhesives and hook and loop fasteners, may be provided within the docking location 644 to facilitate the attachment of the digital recorder 614 to the docking location 644. The digital recorder 614 may additionally include an attachment location 680 for holding a parking card or other similar card, such as an identification card or credit card, although such is not required.

The interior vehicle component 542 includes an eighth embodiment of the digital recorder assembly 710 having a docking location 744. The digital recorder assembly 710 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the eighth embodiment of the digital recorder assembly 710 as illustrated in FIG. 4. Therefore, such corresponding components are indicated by similar reference number in these Figures, but with the components of the second embodiment of the digital recorder assembly 710 having the addition of 700 to each reference number.

As illustrated, the docking location 744 comprises an indentation 744a formed about an edge 750 of the interior vehicle component 542 and extending partially through opposed sides surrounding the edge 750 of the interior vehicle component 542. The indentation 744a is shaped to allow a digital recorder 714 to fit substantially flush to the opposed sides of the interior vehicle component 542 when disposed around the indentation 744a. The digital recorder 714 may be substantially C-shaped, such that the digital recorder assembly 710 extends about the indentation 744a, although such is not required. Additional fasteners (not shown), such as removable adhesives and hook and loop fasteners, may be provided within the docking location 744 to facilitate the attachment of the digital recorder 714 to the docking location 744. A communication interface (not shown) may be located within the indentation 744a, although such is not required. The indentation 744a may be shaped to partially shield the communication interface from contact with other objects or users within the interior of the vehicle 540, although such is not required. As illustrated in FIG. 4, the digital recorder 714 is disposed about the indentation 744a such that the communication interface (not shown) of the digital recorder 714 may be communicably connected to a communications interface (not shown) of the docking location 744, although such is not required.

The interior vehicle component 542 is movable to a first position, illustrated in FIG. 4, and a second position, illustrated in FIG. 4 in phantom. The digital recorder 714 includes a user interface 730 having a plurality of switches 730a, 730b, 730c, 730d, 730e, and 730f. When the digital recorder 714 is disposed within the docking location 744, each of the plurality of switches 730a, 730b, 730c, 730d, 730e, and 730f around the edge 750 of the interior vehicle component 542, such that the plurality of switches 730a, 730b, 730c, 730d, 730e, and 730f are accessible from the interior of the vehicle 540 regardless of whether interior the vehicle component 542 is in the first position or the second position.

The interior vehicle component 542 includes a ninth embodiment of the digital recorder assembly 810 having a docking location 844. The digital recorder assembly 810 is similar to the digital recorder assembly 10 and generally only the components that differ will be described herein. Many of the components of the first embodiment of the digital recorder assembly 10 as illustrated in FIGS. 1 and 2 are similar in structure and function to corresponding components of the ninth embodiment of the digital recorder assembly 810 as illustrated in FIG. 4. Therefore, such corresponding components are indicated by similar reference number in these Figures, but with the components of the second embodiment of the digital recorder assembly 810 having the addition of 800 to each reference number.

As illustrated, the docking location 844 comprises an indentation 844a formed about an edge 852 of the interior vehicle component 542 and extending partially through opposed sides surrounding the edge 852 of the interior vehicle component 542. The indentation 844a is shaped to allow a digital recorder 814 to fit substantially flush to the opposed sides of the interior vehicle component 542 when disposed around the indentation 844a. The digital recorder 814 may be substantially C-shaped, such that the digital recorder assembly 810 extends about the indentation 844a, although such is not required. Additional fasteners (not shown), such as removable adhesives and hook and loop fasteners, may be provided within the docking location 844 to facilitate the attachment of the digital recorder 814 to the docking location 844. Located within the indentation 844a may be a communication interface (not shown). The indentation 844a may be shaped to partially shield the communication interface from contact with other objects or users within the interior of the vehicle 540, although such is not required. As illustrated in FIG. 4, the digital recorder 814 is disposed around the indentation 844a such that the communication interface (not shown) of the digital recorder 814 may be communicably connected to a communications interface (not shown) of the docking location 844, although such is not required.

The digital recorder 814 includes a user interface 830 having a plurality of switches 830a1, 830c1, 830d1, 830d1, 830e1, and 830f1 that are accessible from the interior of the vehicle 540 when the interior vehicle component is in the first position. The user interface 830 includes a plurality of switches 830a2, 830c2, 830d2, 830d2, 830e2, and 830f2 that are accessible from the interior of the vehicle 540 when the interior vehicle component is in the second position. Thus, the user interface 830 allows the digital recorder 814 to be controlled by a user within the interior of the vehicle 540 regardless of whether the interior vehicle component is in the first or second position.

It will be appreciated that the elements described herein for the various embodiments of the digital recorder assembly may be combined or included in any of the various other embodiments of the digital recorder assembly.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A digital recorder assembly for a vehicle comprising:
an interior vehicle component having a docking location, the docking location having a communication interface; and
a digital recorder adapted to be removably positioned within the docking location, the digital recorder having a communication interface communicable to the communication interface of the docking location;
wherein the communications interface of the docking location is capable of transferring power from a vehicle power source to a power source of the digital recorder through the communications interface of the digital recorder when the digital recorder is positioned within the docking location.

2. The digital recorder assembly according to claim 1, wherein the power source of the digital recorder is a rechargeable battery and the communications interface of the docking location is adapted to recharge the rechargeable battery from the vehicle power source when the communication interface of the docking location is communicably connected to the communication interface of the digital recorder.

3. The digital recorder assembly according to claim 1, wherein the docking location includes a recess formed in the interior vehicle component that generally conforms to the shape of the digital recorder

4. The digital recorder assembly according to claim 3, wherein the docking location further includes an aperture formed in the interior vehicle component that is accessible when the digital recorder is positioned within the docking location to facilitate the manual removal of the digital recorder from the docking location.

5. The digital recorder assembly according to claim 1, wherein the communications interface of the docking location and the communication interface of the digital recorder are each capable of transmitting data therebetween.

6. The digital recorder assembly according to claim 1, wherein the communications interface of the digital recorder is capable of transferring data from the digital recorder to an audio system of the vehicle through the communication interface of the docking location when the digital recorder is positioned within the docking location.

7. The digital recorder assembly according to claim 1, wherein the digital recorder device comprises an integrated circuit microchip capable of performing recording and playback functions that includes memory, DSP, DAC, and amplification devices.

8. A digital recorder assembly for a vehicle comprising:
an interior vehicle component having a docking location, the docking location having a communication interface; and
a digital recorder adapted to be positioned within the docking location, the digital recorder having a communication interface communicable to the communication interface of the docking location;
wherein the communications interface of the digital recorder is capable of transferring data from the digital recorder to an audio system of the vehicle through the communication interface of the docking location when the digital recorder is positioned within the docking location.

9. The digital recorder assembly according to claim 8, wherein the data transferred includes commands to control the volume of the audio system.

10. The digital recorder assembly according to claim 8, wherein the data transferred includes an audio signal representative of a message stored on the digital recorder to be played by the audio system.

11. The digital recorder assembly according to claim 8, wherein the communications interface of the docking location is capable of transferring power from a vehicle power source to a power source of the digital recorder through the communications interface of the digital recorder when the digital recorder is positioned within the docking location, and wherein the power source of the digital recorder is a rechargeable battery and the communications interface of the docking location is adapted to recharge the rechargeable battery from the vehicle power source when the communication interface of the docking location is communicably connected to the communication interface of the digital recorder.

12. The digital recorder assembly according to claim 8, wherein the communications interface of the docking location is capable of transferring data from the audio system to the digital recorder through the communication interface of the digital recorder when the digital recorder is positioned within the docking location.

13. The digital recorder assembly according to claim 12, wherein the data transferred from the audio system to the digital recorder includes the input signal from a microphone connected to the audio system.

14. A digital recorder assembly for a vehicle comprising:
an interior vehicle component disposed within an interior compartment of a vehicle, the interior vehicle component having a docking location and being movable to a first position and a second position; and
a digital recorder adapted to be positioned within the docking location, the digital recorder having a user interface operable to control the operation of the digital recorder;
wherein the user interface is accessible from the interior compartment when the digital recorder is positioned in the docking location and the interior vehicle component is in either the first position or the second position.

15. The digital recorder assembly according to claim 14, wherein the interior vehicle component is a visor.

16. The digital recorder assembly according to claim 14, wherein the user interface comprises a plurality of switches, each of the plurality of switches extending about an edge of the interior vehicle component, such that each of the plurality of switches is accessible from the interior compartment of the vehicle when the interior vehicle component is in the first position and the second position.

17. The digital recorder assembly according to claim 14, wherein the user interface comprises a first plurality of switches and a second plurality of switches, each of the first plurality of switches is accessible from the interior compartment of the vehicle when the interior vehicle component is in the first position and each of the second plurality of switches is accessible from the interior compartment of the vehicle when the interior vehicle component is in the second position.

18. The digital recorder assembly according to claim 14, wherein the vehicle includes a communications interface that is capable of transferring power from a vehicle power source to a power source of the digital recorder through a communications interface of the digital recorder when the digital recorder is positioned within the docking location.

19. The digital recorder assembly according to claim 18, wherein the power supply of the digital recorder is a rechargeable battery and the communications interface of the docking location is adapted to recharge the rechargeable battery from the vehicle power source when the communication interface of the docking location is communicably connected to the communication interface of the digital recorder.

20. The digital recorder assembly according to claim 18, wherein the communications interface of the vehicle is a power output and the communications interface of the digital recorder is a power input communicably connectable to the power output.
